(19) United States
(12) Patent Application Publication
(10) Pub. No.: US 2019/0279103 A1
(43) Pub. Date: Sep. 12, 2019

(54) SYSTEMS AND METHODS FOR DETERMINING MOST PROBABLE CAUSE OF AN EVENT

(71) Applicant: TRIAH LABS PVT. LTD., BANGALORE, KARNATAKA (IN)

(72) Inventors: Gautam Kasthuri RANGAN, BANGALORE (IN); Srikanth TADEPALLI, BANGALORE (IN); Bhaskar PAI, BANGALORE (IN)

(21) Appl. No.: 16/288,872

(22) Filed: Feb. 28, 2019

(30) Foreign Application Priority Data
Mar. 9, 2018 (IN) 201841008674

(51) Int. Cl. G06N 5/04; G06F 16/93; H05B 37/02

(52) U.S. Cl. CPC G06N 5/045; H05B 37/0272; G06F 16/93

(57) ABSTRACT

A system for determining a most probable cause of an event is presented. The system includes a processing subsystem coupled to a smart lighting subsystem and is configured to receive an event signature from the smart lighting subsystem, determine an event based on the event signature, determine an entropy of the event, connect with a plurality of historical data documents, determine information gain of at least a first subset of the plurality of historical data documents, identify and index a plurality of relevant documents from the first subset of the plurality of historical data documents based on the information gain and a determined threshold, determine one or more probable reasons of the event based on the plurality of relevant documents, and determine the most probable cause of the event at least based on the probable reasons, the plurality of relevant documents and the plurality of historical data documents.

### CROSS-REFERENCE TO RELATED APPLICATION

This application is based upon and claims the benefit of priority from Indian Patent Application No. 2018-41008674, filed on Mar. 9, 2018, the contents of which are incorporated herein by reference.

### BACKGROUND

The invention relates generally to monitoring systems and in particular to smart lighting monitoring systems.

Identifying most probable cause of a problem or an event may aid in identifying appropriate techniques of solving the problem or making the event productive. For example, remedial interventions may be initiated based on the identified most probable cause. Additionally, or alternatively, potential occurrence of the problem or the event may be prevented based on the identified most probable cause. For example, identifying the most probable cause of traffic congestion on a street on certain days may aid in reducing or eliminating potential traffic congestion. Similarly, identifying the most probable cause of a failure of a component of a sophisticated machine may be used to prevent future failures. Similarly, identifying reasons of a fall of an unattended elderly person may help in connecting with an appropriate healthcare department and providing appropriate health interventions.

Human representatives or operators typically identify most probable cause based on limited available data. Also, determination of the most probable cause by human representatives or operators is dependent on the competence, an amount of available information/data and limited understanding of inter-relationships between data. For example, a component of an engine may fail due to numerous reasons and manual determination of reasons such failure may be inaccurate. In some instances, determination of the probable cause by human intervention may be impossible or may lead to unwarranted delay. For instance, delay in identifying a reason of a fall of an unattended elderly person may lead to delay in connecting with appropriate healthcare department.

Accordingly, methods and systems are required to identify cause of problems or events, and take appropriate actions based on the cause of the problems or events.

### SUMMARY OF THE INVENTION

In accordance with one embodiment of the present invention, a system for determining a most probable cause of an event is presented. The system includes a processing subsystem coupled to a smart lighting subsystem and configured to receive an event signature from the smart lighting subsystem, determine an event based on the event signature, determine an entropy of the event, connect with a plurality of historical data documents, determine information gain of at least a first subset of the plurality of historical data documents, identify and index a plurality of relevant documents from the first subset of the plurality of historical data documents based on the information gain and a determined threshold, determine one or more probable reasons of the event based on the plurality of relevant documents, and determine the most probable cause of the event at least based on the one or more probable reasons, the plurality of relevant documents and the plurality of historical data documents.

In accordance with another embodiment, a method for determining a most probable cause of an event is presented. The method includes receiving an event signature from a smart lighting subsystem, determining the event based on the event signature, determining an entropy of the event, connecting with a plurality of historical data documents, determining information gain of at least a subset of the plurality of historical data documents, identifying and indexing a plurality of relevant documents from the subset of the plurality of historical data documents based on the information gain and a determined threshold, determining one or more probable reasons of the event based on the plurality of relevant documents, and determining the most probable cause of the event at least based on the one or more probable reasons, the plurality of relevant documents and the plurality of historical data documents.

These and other features, aspects, and advantages of the present invention will become better understood when the following detailed description is read with reference to the accompanying drawings in which like characters represent like parts throughout the drawings.

### BRIEF DESCRIPTION OF THE DRAWINGS

FIG. 1 is a block diagram of a monitoring system for determining a most probable cause of an event, in accordance with one embodiment of the invention;

FIG. 2 is a flowchart of a method for determining the most probable cause of an event, in accordance with one embodiment of the invention;

FIG. 3 is a flowchart of a method for determining an information gain of a first subset of a plurality of historical data documents, in accordance with one embodiment of the invention;

FIG. 4 is a flowchart of a method for determining probable reasons, in accordance with one embodiment of the invention;

FIG. 5 is a flowchart of a method for determining a most probable cause of an event, in accordance with one embodiment of the invention; and

FIG. 6 is a flowchart of a method for determining a probability of occurrence of a potential incident that requires immediate attention, in accordance with one embodiment of the invention.

### DETAILED DESCRIPTION

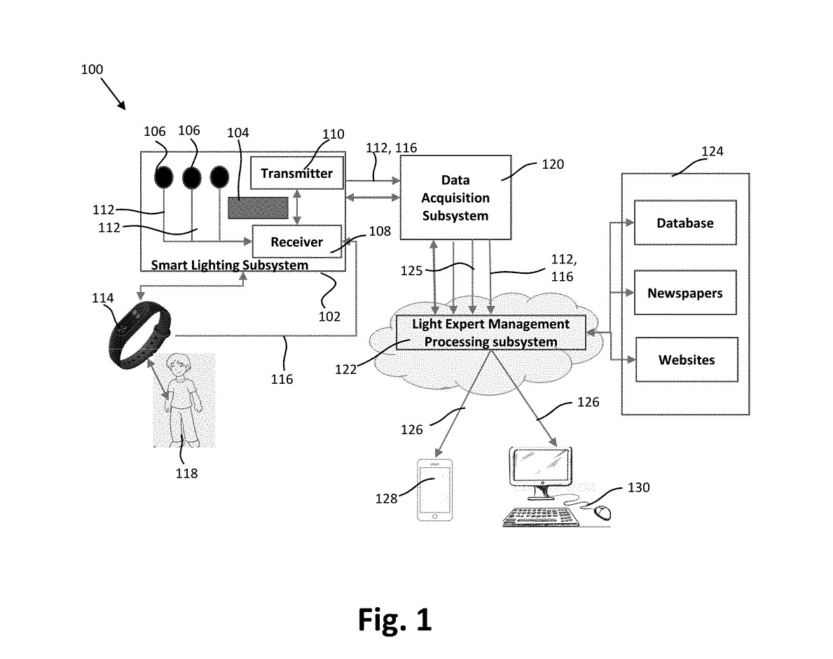

FIG. 1 is a block diagram of a monitoring system 100 for determining occurrence of an event and determining a most probable cause 126 of an event, in accordance with one embodiment of the invention. Subsequent to the determination of the most probable cause 126 of the event, the monitoring system 100 may determine and initiate remedial interventions based on the most probable cause 126. Additionally, or alternatively, a potential occurrence of the problem or the event may be prevented from based on the most probable cause 126.

The event may depend on the domain of application of the monitoring system. For instance, when the monitoring system 100 is used in healthcare domain to monitor unattended elderly parents, then the event may include a fall of an elderly parent. The event may be a positive or a negative event. For example, the event may include traffic congestion, smooth traffic, defect in a machine or a component, fall in ‘vital’ signs of a patient, e.g., heartbeat, pulse.

In the presently contemplated configuration, the monitoring system 100 includes a smart lighting subsystem 102. The smart lighting subsystem 102 includes a lighting source 104 configured to produce and emit light for illuminating an area. The smart lighting subsystem 102 may include a Li-Fi enabled smart lighting subsystem, a light mounted on at least one of a wall, a ceiling, a pole or combinations thereof.

The smart lighting subsystem 102 further includes a plurality of sensors 106, a receiver 108 and a transmitter 110. The sensors 106 sense an activity or a change in a status inside the area. Post sensing, the sensors 106 generate a data signature 112 representative of anactivity or the change in status. By way of a non-limiting example,the sensors 106 may detect occupancy in the area, a pressure in the area, a temperature in the area and/or a change in temperature or pressure. Again, by way of a non-liming example, the sensors 106 may include a motion sensor, an occupancy sensor, a temperature sensor and a pressure sensor, gas leak sensor, smoke sensor, Time of Flight sensors. The sensors 106 are configured to transmit the data signature 112 to the receiver 108.

In certain embodiments, the monitoring system 100 additionally includes a wearable band 114 configured to sense and generate signals 116 representative of physiological measurements of a user 118 wearing the wearable band. The wearable band, for example may be a BLE (Bluetooth Low Energy) enabled band. By way of a non-limiting example, the physiological measurements may be vital signs including Blood Pressure Rate, Heart Rate (arrhythmias), Breath Rate (respirations), ECG/EKG (Electro-cardiogram), Respirations (breaths) Per Minute, Blood Oxygen Levels and Blood Temperature.

The wearable band 114 and the sensors 106 are operationally coupled to the receiver 108. The wearable band 114 may be coupled to the smart lighting subsystem 102 via Bluetooth and/or or a wireless medium. The wearable band 114 is configured to transmit the signals 116 representative of the physiological measurements to the receiver 108. The receiver 108 receives the signals 116 from the wearable band 114 and the data signature 112 from the sensors 106. Furthermore, the receiver 108 is operationally coupled to the transmitter 110.

As shown in FIG. 1, the monitoring system 100 additionally includes a data acquisition subsystem 120. In one embodiment, the data acquisition subsystem 120 may be located in proximity to a location of the smart lighting subsystem 102. In another embodiment, the data acquisition subsystem 120 may be located remotely from a location of the smart lighting subsystem 102. The data acquisition subsystem 120 is operationally coupled to the smart lighting subsystem 102. Specifically, in the presently contemplated configuration, the data acquisition subsystem 120 is operationally coupled to the transmitter 110. The transmitter 110 transmits the data signature 112 and/or the signals 116 to the data acquisition subsystem 120. It is noted that for technical feasibility, the transmitter 110 may incorporate some minor alterations in the original data signature 112 and the signals 116 before transmitting to the data acquisition subsystem 120. It is noted that in certain embodiments, the wearable band 114 may directly transmit the signals 116 to the data acquisition subsystem 120.

The data acquisition subsystem 120 is configured to receive the data signature 112 and the signals 116 from the transmitter 110. In certain embodiments, the data acquisition subsystem 120 may receive the signals 116 from the wearable band 114. The data acquisition subsystem 120 may perform initial processing on the data signature 112 and the signals 116. For example, the data acquisition subsystem 120 may filter the data signature 112 and the signals 116 to remove noise from the data signature 112 and/or signals 116. Furthermore, the data acquisition subsystem 120 may determine an occurrence of an event based on the data signature 112 and/or the signals 116. For example, the data acquisition subsystem 120 may compare the data signature 112 and/or the signals 116 to one or more thresholds to determine an occurrence of the event. In one embodiment, a combined value may be determined based on the data signature 112 and/or the signals 116, and the combined value may be compared to a pre-determined combined threshold to determine the occurrence of the event. For example, when the data signature 112 and/or the signals 116 exceed the thresholds or the combined value exceeds the combined threshold, then the occurrence of the event may be determined. In the presently contemplated configuration, when the occurrence of the event is determined, an event signature 125 representative of the event may be generated by the data acquisition subsystem 120.

The monitoring system 100 further includes a light expert management processing subsystem (LEMPS) 122 operationally coupled to the data acquisition subsystem 120. In one embodiment, the LEMPS 122 may be a cloud computing subsystem and may offer software as a service (SaaS) to respective users. In one embodiment, the LEMPS 122 is operationally coupled to the smart lighting subsystem 102. In another embodiment, the LEMPS 122 is coupled to the data acquisition subsystem 120. The LEMPS 122 is configured to receive the event signature 125, the data signature 112 and/or the signals 116 from the data acquisition subsystem 120.

The LEMPS 122 is operationally coupled to a plurality of historical data documents 124 and the data acquisition subsystem 120. The historical data documents 124 may include databases, newspapers, websites, or the like. The historical data documents 124 may depend on the application of the monitoring subsystem 100. For example, when the monitoring subsystem 100 is used in medical or healthcare applications, then the historical data documents 124 includes medical literature, research papers journals, blogs, repositories of trauma cases.

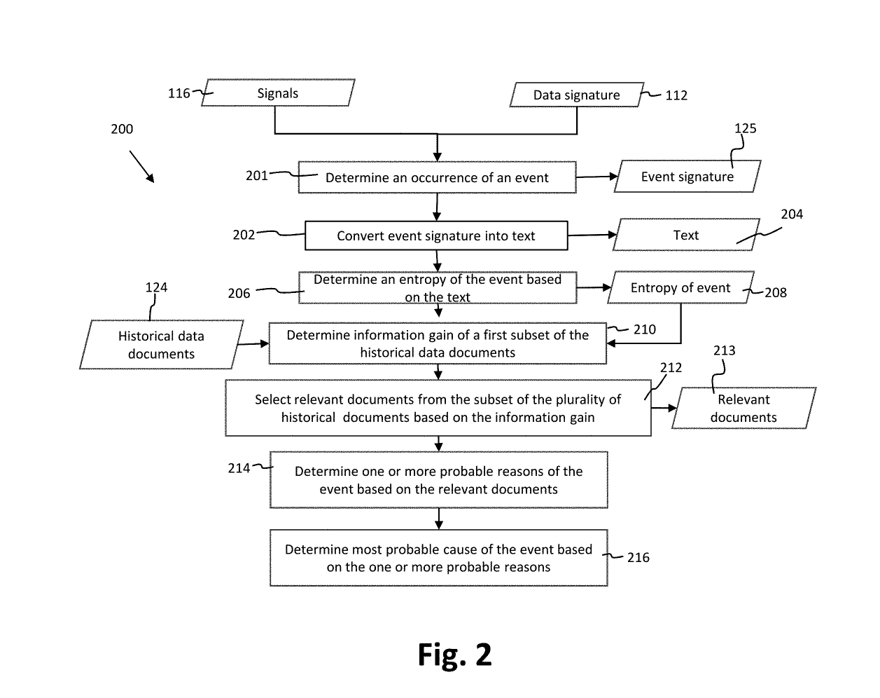

The LEMPS 122 receives the event signature 125, the data signature 112 and/or the signals 116 from the data acquisition subsystem 120. Subsequently the LEMPS 122 may determine the most probable cause 126 of the event and/or the related event at least based on the event signature 125. Determination of the most probable cause 126 of the event is explained in greater detail with reference to FIGS. 2-5. The LEMPS 122 may categorize the event as a regular event, a caution event, a chronic condition or an emergency based on the most probable cause 126. Additionally, the LEMPS 122 may inform appropriate representatives about the event and/or the most probable cause 126. In one embodiment, the LEMPS 122 may inform the appropriate representatives. For example, the LEMPS 122 may inform the appropriate representatives based on the categorization of the events. For example, when the event signature 125 identify the event namely “fall”, the LEMPS 122 may determine the most probable cause of the fall as heart attack, and categorize the event as an emergency. Thereafter, the LEMPS 122 may inform the appropriate healthcare institutions and relatives about the heart attack. In the presently contemplated configuration, the LEMPS 122 transmits a message informing about the most probable cause 126 to a mobile device 128 and a computer 130. The mobile device 128 and the computer 130 may belong to a user, a healthcare professional or a relative.

FIG. 2 is a flowchart of a method 200 for determining an event and determining a most probable cause of the event, in accordance with one embodiment of the invention. Block 112 is representative of the data signature generated by the sensors 106 referred to in FIG. 1. Block 116 is representative of the signals generated by the wearable band 114 referred to in FIG. 1.

At block 201, an occurrence of the event may be determined based at least on one of the data signature 112 and the signals 116. Block 201 may be executed by the data acquisition subsystem 120 or the LEMPS 122. As previously noted with reference to FIG. 1, the occurrence of the event may be determined by comparing the data signature 112 and the signals 116 to respective thresholds. When the data signature 112 and the signals 116 exceed the respective thresholds, then the occurrence of the event may be determined. Consequent to the determination of the occurrence of the event, the event signature 125 representative of the event may be generated.

Subsequently at block 202, the event signature 125 may be converted to text 204. By way of a non-limiting example, the event signature 125may be converted into the text 204 based on a table. The text, for example, may be a combination one or more of a noun, verb and adjective. For example, the text 204 may include ‘aged man climb.’ The event signature 125 may be converted into the text 204 by mapping digital values of the event signature 125 to the text 204 using the table. The text 204 is representative of the event. In other words, the text 204 identifies the event. For example, text “Fall” is representative of fall of an event.

At block 206, an entropy 208 of the event may be determined based on the text 204. For example, the entropy 208 of the event may be determined using the following equation (1):

H(X)=−Σᵢ₌₁ⁿp(xᵢ)log₂ p(xᵢ) (1)

where X is a discrete random variable X representing the event, with possible states (or outcomes) as (x₁, x₂, . . . xₙ), p(xᵢ) is the probability of the i^{th} outcome of X.

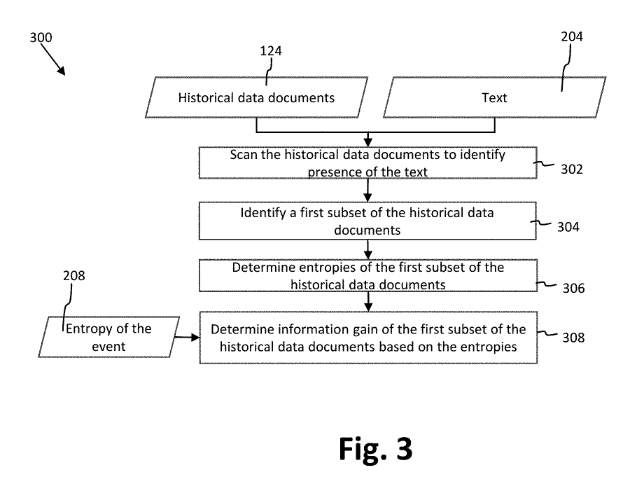

At block 210, information gain of a first subset of the plurality of historical data documents 124 may be determined. The information gain of the first subset of the historical data documents 124 may be determined at least based on the entropy 208 of the event. Determination of the information gain of the first subset of the historical data documents 124 is explained in greater detail with reference to FIG. 3. Furthermore, at block 212 relevant documents 213 may be identified and indexed from the first subset of the historical data documents 124. Particularly, the relevant documents 213 may be identified and indexed based on the information gain of the first subset of the historical data documents 124. For example, the LEMPS 122 may identify a historical data document A as a relevant document 213 when an information gain corresponding to the historical data document A is greater than a determined threshold. Additionally, the LEMPS 122 may index the relevant documents 213 based on respective information gain. For example, higher the information gain, higher is a relevance ranking of the relevant document. As used herein, the term “relevance ranking” is representative of relevance of the relevant document to the event.

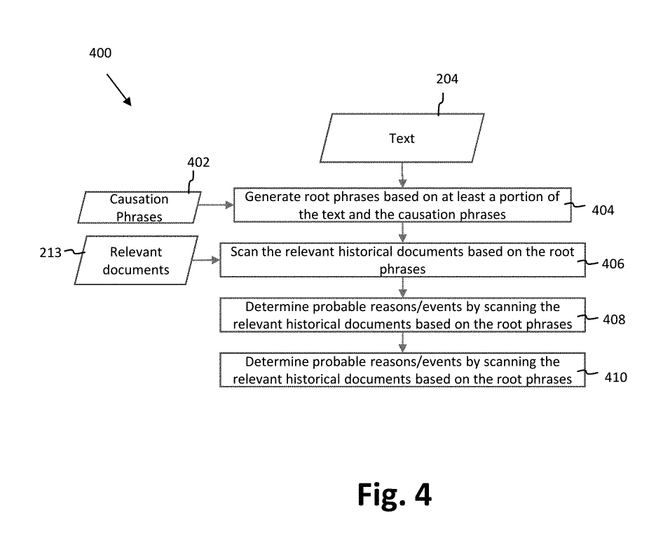

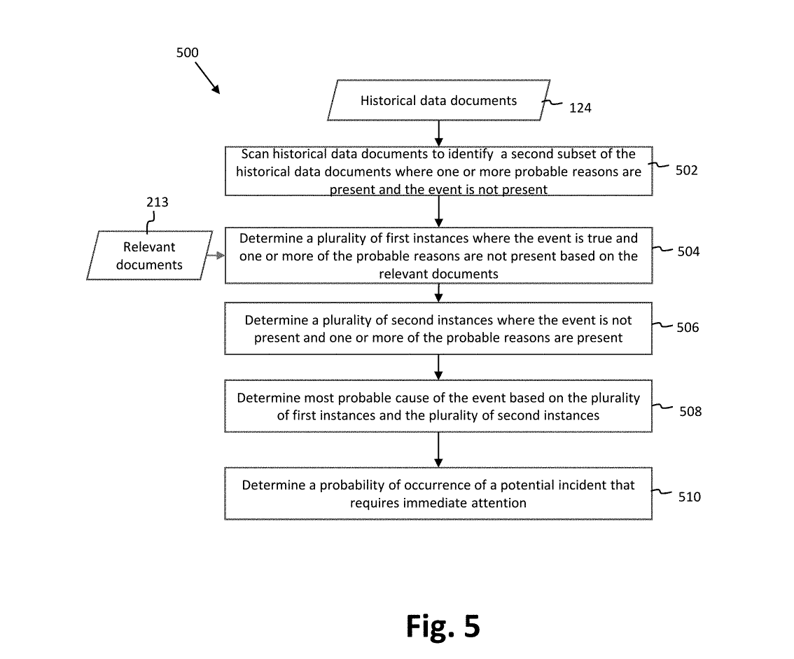

Furthermore, at block 214 one or more probable reasons of the event may be determined based on the relevant documents. Determination of the probable reasons is explained in greater detail with reference to FIG. 4. Subsequently at block, 216 most probable cause of the event may be determined based on the probable reasons. Determination of the probable reasons based on the most probable cause is explained in greater detail with reference to FIG. 5.

FIG. 3 is a flowchart of a method 300 for identifying the first subset of the historical data documents 124 and determining the information gain of the first subset of the historical data documents 124, in accordance with one embodiment of the invention. Particularly, FIG. 3 explains block 210 of FIG. 2 in greater detail. As previously noted with reference to FIG. 1 and FIG. 2, reference numeral 124 is representative of historical data documents and reference numeral 204 is representative of the text identifying the event.

At block 302, the historical data documents 124 may be scanned to search for a presence of the text 204. The search, for example, may include a key-word natural language processing search. For example, if the text 204 include “heart attack”, then the historical data documents 124 may be searched to identify a presence of the word “heart attack.” At block 304, the first subset of the historical data documents 124 may be identified based on the presence of the text 204 in the historical data documents 124. Particularly, one or more historical data documents that include the text 204 are identified as the firs subset of the historical data documents 124.

Furthermore, at block 306, entropies of the first subset of the historical data documents 124 may be determined. In one embodiment, an entropy corresponding to each of the first subset of the historical data documents may be determined. For example, if the first subset of the historical data documents 124 include 10 articles/documents, then an entropy corresponding to each of the 10 documents/articles may be determined. The entropy of the first subset of the historical data documents 124 may be determined using the following equation (2).

H(B)==−Σᵢ₌₁ⁿp(xᵢ)log₂ p(xᵢ) (2)

wherein B is a discrete random variable B representing the event, with possible states (or outcomes) as (x₁, x₂, . . . xₙ), p(xᵢ) is the probability of the i^{th} outcome of X.

Subsequently at block 308, an information gain corresponding to the first subset of the historical data documents 124 may be determined. In one embodiment, the information gain corresponding to each of the first subset of the historical data documents 124 may be determined. The information gain corresponding to the first subset of the historical data documents 124 may be determined based on the entropy 208 of the event and entropies of the first subset of the historical data documents 124. For example, the information gain may be determined using the following equation (3).

Information gain=H(B)−(H(A)*H(B)) (3)

wherein H(A) is entropy of the signature, and H(B) is entropy of a document in the first subset of the historical data documents.

FIG. 4 is a flowchart of a method 400 for determining probable reasons, in accordance with one embodiment of the invention. Particularly, FIG. 4 explains block 214 of FIG. 2 in greater detail. As previously noted, reference numeral 204 is representative of text identifying the event. Furthermore, reference numeral 402 is representative of causation phrases. The causation phrases may be prestored, and may be retrieved from a data repository. The causation phrases 402, for example may include ‘attributed to,’ ‘due to,’ ‘because of,’ or a combination thereof. At block 404, one or more root phrases may be generated based on the causation phrases 402 and the text 204. For example, the causation phrases 402 and the text 204 may be combined to generate the root phrases. For instance, a causation phrase “due to” and a text “heart attack” may be combined to generate a root phrase “heart attack due to.”

Furthermore, at block 406 the relevant documents 213 may be searched to identify a presence of the root phrases. For example, when the root phrase includes “heart attack due to”, then the relevant documents 213 may be searched to identify the presence of the root phrase “heart attack due to” in the relevant documents 213. Subsequently at block 408, the probable reasons may be determined based on the identification of the presence of the root phrases in the relevant documents 213. Particularly, one or more words in the immediate vicinity of the root phrases may be extracted and equated to the probable reasons. For example, when a relevant document has a statement “heart attack due to high BP”, then the words “high BP” are extracted as a probable cause of heart attack.

FIG. 5 is a flowchart of a method 500 for determining a most probable cause of an event, in accordance with one embodiment of the invention. Reference numeral 124 is representative of historical data documents. At block 502, the historical data documents 124 may be scanned to identify a second subset of the historical documents 124. The historical data documents 124 may be scanned to identify a presence of the probable reasons. The probable reasons are the reasons identified at block 214 of FIG. 2 or block 408 of FIG. 4. At block 504, a plurality of first instances may be determined where the event is present and the probable reasons are not present based on the relevant documents 213. For example, when the event is “heart attack” and the probable reasons include “high BP” and “high cholesterol”, then the relevant documents 213 are searched to identify one or more documents where “heart attack” is present, but “high BP” and “high cholesterol” are not present.

Subsequently at block 506, a plurality of second instances are determined where the event is not present but one or more of the probable reasons are present based on the relevant documents 213. For example, when the event is “heart attack” and the probable reasons include “high BP” and “high cholesterol”, then the relevant documents 213 are searched to identify one or more documents where “heart attack” is not present, and one or both of “high BP” and “high cholesterol” are present. The plurality of first instances and the plurality of second instances may be represented by the following Table 1.

TABLE 1

| | | First | Second | Third |
|---|---|---|---|---|
| | | probable | probable | probable |
| | Event | cause | cause | cause |
| | (e.g. Fainted) | P₁: Diabetes | P₂: e.g., Impact | P₃: Smoking |
| Instance 1 | True | False | False | False |
| Instance 2 | False | False | True | False |
| Instance 3 | False | True | False | True |

Furthermore, at block 508, a most probable cause of the event may be determined based on the first instances and the second instances. The most probable cause of the event, for example may be determined by generating a decision tree based on the first instances and the second instances. The decision tree breaks down a dataset into smaller subsets via a drill down tree structure with entropy values at each node. The final result is a tree with decision nodes and leaf nodes. A decision node has two or more branches. Leaf node represents a classification or decision. The topmost decision node in a tree is a root node. The text 204 identifying the event signature is included in the root node. Iterative Dichotomiser 3 or greedy search methods may employed to decide the ordering of the child nodes or the branches. A leaf node of the decision tree may be determined as the most probable cause.

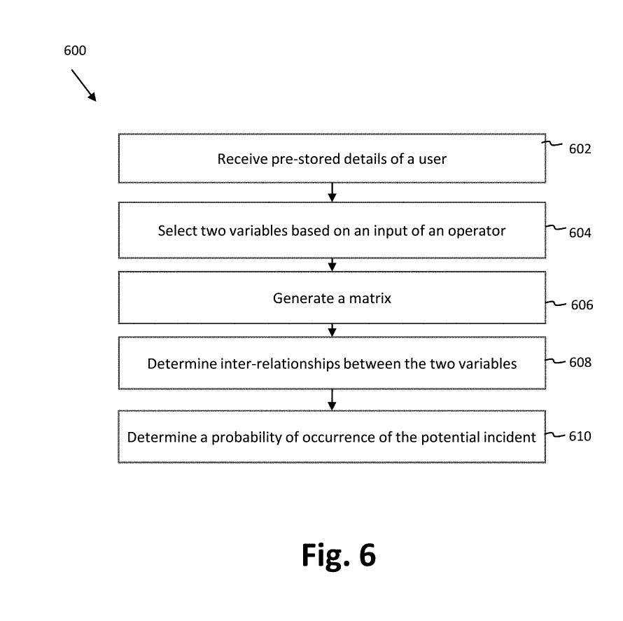

In certain embodiments, at block 510, a probability of occurrence of a potential incident that requires immediate attention is determined. The probability of occurrence of the potential incident may be determined using dominant strategy equilibrium. Determination of the probability of occurrence of the potential incident is explained in greater detail with reference to FIG. 6.

FIG. 6 is a is a flowchart of a method 600 for determining a probability of occurrence of a potential incident that requires immediate attention, in accordance with one embodiment of the invention. Particularly, FIG. 6 explains block 510 of FIG. 5 in greater detail. At block 602, pre-stored details of a user may be received. In one embodiment, the user, for example, may be the user 118, wearing the wearable band 114, referred to in FIG. 1. In another embodiment, the user may be an occupant of the area being monitored by the smart lighting subsystem 102 referred to in FIG. 1. At block 604, two variables may be selected. The variables, for example may be one or more of the probable reasons determined at block 408.

Thereafter at block 606, a matrix (N*M) may be generated based on the two variables, the one or more probable reasons, inputs of the operator, the pre-stored details of the user, the historical data documents 124, or a combination thereof. Subsequently, at block 608 inter-relationships between the two variables may be determined based on the matrix using a dominant strategy equilibrium method. An example of the matrix where the two variables include Insulin levels and BP is shown below in Table 2.

TABLE 2

Insulin
Levels

| | | Low | High |
|---|---|---|---|
| BP | Low | a, b | c, d |
| | High | e, f | g, h |

For example, in the above matrix when ‘a’ is greater than ‘e’, and ‘c’ is greater than ‘g’, then low BP dominates. Similarly, if ‘b’ is greater than ‘d’ and ‘f’ is greater than ‘h’ then insulin level dominates. Furthermore, at block 610, the probability of occurrence of the potential incident may be determined based on the inter-relationships between the two variables.

Subsequently, at block 610 the probability of the occurrence of the potential incident may be determined based on the inter-relationships between the variables of the matrix. For example, when high BP dominates and the event shows “fall” and “no movement”, then the possibility of potential heart attack may be determined.

The present systems and methods automatically determines occurrence of events, and probable reasons for the occurrence of these events. The present systems and methods additionally determines and initiates remedial interventions based on the probable reasons. Additionally, or alternatively, a potential occurrence of the problem or the event may be prevented from based on the most probable cause.

While only certain features of the invention have been illustrated and described herein, many modifications and changes will occur to those skilled in the art. It is, therefore, to be understood that the appended claims are intended to cover all such modifications and changes as fall within the true spirit of the invention.

We claim:

1. A system for determining a most probable cause of an event, comprising:
a processing subsystem coupled to a smart lighting subsystem and configured to:
receive an event signature from the smart lighting subsystem;
determine an event based on the event signature;
determine an entropy of the event;
connect with a plurality of historical data documents;
determine information gain of at least a first subset of the plurality of historical data documents;
identify and index a plurality of relevant documents from the first subset of the plurality of historical data documents based on the information gain and a determined threshold;
determine one or more probable reasons of the event based on the plurality of relevant documents; and
determine the most probable cause of the event at least based on the one or more probable reasons, the plurality of relevant documents and the plurality of historical data documents.

2. The system of claim 1, wherein the processing subsystem is configured to determine the event by converting the event signature into text.

3. The system of claim 1, wherein the processing subsystem is configured to determine the information gain of at least the first subset of the plurality of historical data documents by:
scanning the plurality of historical data documents to identify a presence of the text in the plurality of historical data documents;
determining the first subset of the plurality of historical data documents based on the presence of the text in the plurality of data documents;
determining a plurality of entropies of the first subset of the plurality of historical data documents; and
determining the information gain of the first subset of the plurality of historical data documents based on the plurality of entropies of the first subset of the plurality of historical data documents and the entropy of the event.

4. The system of claim 1, wherein the processing subsystem is configured to determine one or more probable reasons by:
generating root phrases based on at least a portion of the text and one or more causation phrases; and
determining the one or more probable reasons based on the plurality of relevant documents and the root phrases.

5. The system of claim 4, wherein the one or more causation phrases comprises terms comprising ‘attributed to,’ ‘due to,’ ‘because of,’ or a combination thereof.

6. The system of claim 1, wherein the processing subsystem is configured to determine the most probable cause by:
scanning the plurality of historical data documents to identify a second subset of the plurality of historical data documents wherein the event is absent and the one or more probable reasons are present;
determining a plurality of first instances wherein the event is present and at least one of the one or more probable reasons are absent based on the second subset of the plurality of historical data documents;
determining a plurality of second instances wherein the event is not present and at least one of the one or more probable reasons is present; and
determining a most probable cause of the event based on the plurality of first instances and the plurality of second instances.

7. The system of claim 6, wherein determining the most probable cause comprises:
generating a decision tree based on the plurality of first instances and the plurality of second instances; and
determining the most probable cause by equating a leaf node of the decision tree to the most probable cause of the event.

8. The system of claim 1, further comprising:
a plurality of sensing devices disposed in the smart lighting subsystem and configured to generate the data signature representative of a measurement or an activity; and
a receiver coupled to the plurality of sensing devices and the processing subsystem, wherein the receiver is configured to receive the data signature from the plurality of sensing devices and transmit the data signature to the processing subsystem.

9. The system of claim 1, wherein the processing subsystem comprises a cloud computing subsystem.

10. The system of claim 1, wherein the smart lighting subsystem comprises a Li-Fi enabled smart lighting subsystem, a light mounted on at least one of a wall, a ceiling, a pole or combinations thereof.

11. The system of claim 1, further comprising a wearable band configured to:
generate signals representative of physiological measurements of a user wearing the wearable band; and
transmit the signals representative of the physiological measurements to the receiver.

12. The system of claim 10, wherein the processing subsystem is further configured to:
receive pre-stored details of the user from a data repository;
select two variables based on inputs of an operator;
generate a matrix (N*M) based on the two variables, the one or more probable reasons, inputs of the operator, the pre-stored details of the user, the plurality of historical data documents, or a combination thereof;
determine, using dominant strategy equilibrium, interrelationships between the two variables based on the matrix;
determine a probability of occurrence of a potential incident that requires immediate medical attention.

13. A method for determining a most probable cause of an event, comprising:
receiving an event signature from a smart lighting subsystem;
determining the event based on the event signature;
determining an entropy of the event;
connecting with a plurality of historical data documents;
determining information gain of at least a subset of the plurality of historical data documents;
identifying and indexing a plurality of relevant documents from the subset of the plurality of historical data documents based on the information gain and a determined threshold;
determining one or more probable reasons of the event based on the plurality of relevant documents; and
determining the most probable cause of the event at least based on the one or more probable reasons, the plurality of relevant documents and the plurality of historical data documents.

14. The method of claim 13, wherein the processing subsystem is configured to determine the event by converting the event signature into text.

15. The method of claim 13, wherein the processing subsystem is configured to determine the information gain of at least the first subset of the plurality of historical data documents by:
scanning the plurality of historical data documents to identify a presence of the text in the plurality of historical data documents;
determining the first subset of the plurality of historical data documents based on the presence of the text in the plurality of data documents;
determining a plurality of entropies of the first subset of the plurality of historical data documents; and
determining the information gain of the first subset of the plurality of historical data documents based on the plurality of entropies of the first subset of the plurality of historical data documents and the entropy of the event.

16. The system of claim 13, wherein the processing subsystem is configured to determine one or more probable reasons by:
generating root phrases based on at least a portion of the text and one or more causation phrases wherein the one or more causation phrases comprises terms comprising ‘attributed to,’ ‘due to,’ ‘because of,’ or a combination thereof; and
determining the one or more probable reasons based on the plurality of relevant documents and the root phrases.

17. The method of claim 13, wherein the processing subsystem is configured to determine the most probable cause by:
scanning the plurality of historical data documents to identify a second subset of the plurality of historical data documents, wherein the event is absent and the one or more probable reasons are present;
determining a plurality of first instances wherein the event is present and at least one of the one or more probable reasons are not present based on the second subset of the plurality of historical data documents;
determining a plurality of second instances wherein the event is not present and at least one of the one or more probable reasons is present; and
determining a most probable cause of the event based on the plurality of first instances and the plurality of second instances.

18. The method of claim 16, wherein determining the most probable cause comprises:
generating a decision tree based on the plurality of first instances and the plurality of second instances: and
determining the most probable cause by equating a leaf node of the decision tree to the most probable cause of the event.

19. A system for determining a most probable cause of an event, comprising:
a plurality of sensing devices configured to generate a data signature representative of a measurement or activity;
a wearable band configured to generate signals representative of physiological measurements of a user wearing the wearable band;
a receiver, coupled to the plurality of sensing devices and the wearable band, configured to receive the data signature from the plurality of sensing devices and the signals representative of physiological measurements;
a data acquisition subsystem coupled to the receiver and configured to acquire the data signature and the signals representative of the physiological measurements from the receiver;
a processing subsystem coupled to a smart lighting subsystem and configured to:
receive a data signature from the smart lighting subsystem;
generate an event signature based on the data signature;
determine an event based on the event signature;
connect with resources comprising a plurality of historical data documents;
determine information gain of at least a subset of the plurality of historical data documents;
identify and index a plurality of relevant documents based on the information gain and a determined threshold;
determine one or more probable reasons of the event based on the at least one document; and
determine the most probable cause of the event at least based on the one or more probable reasons, the plurality of relevant documents and the plurality of historical data documents.

20. The system of claim 19, wherein the processing subsystem is configured to determine the information gain of at least the first subset of the plurality of historical data documents by:
scanning the plurality of historical data documents to identify a presence of the text in the plurality of historical data documents;
determining the first subset of the plurality of historical data documents based on the presence of the text in the plurality of data documents;
determining a plurality of entropies of the first subset of the plurality of historical data documents; and
determining the information gain of the first subset of the plurality of historical data documents based on the plurality of entropies of the first subset of the plurality of historical data documents and the entropy of the event.
